(19) United States
(12) Patent Application Publication
(10) Pub. No.: US 2007/0068920 A1
(43) Pub. Date: Mar. 29, 2007

(54) Bake unit, method for cooling heating plate used in the bake unit, apparatus and method for treating substrates with the bake unit

(76) Inventors: Hee-Young Kang, Cheonan-city (KR); Sung-Hwan Yim, Cheonan-city (KR)

Correspondence Address: HARNESS, DICKEY & PIERCE, P.L.C., P.O. BOX 8910, RESTON, VA, 20195, US

(21) Appl. No.: 11/274,204

(22) Filed: Nov. 16, 2005

(30) Foreign Application Priority Data
Sep. 28, 2005 (KR) 2005-90371

(51) Int. Cl. H05B 3/68

(52) U.S. Cl. 219/444.1

(57) ABSTRACT

There is provided a method for cooling a heating plate used in a bake unit. According to the method, the heating plate is cooled with a temperature adjustment plate that is cooler than the heating plate by providing the temperature adjustment plate on the heating plate. The temperature adjustment plate is moved to the heating plate after the temperature adjustment plate is cooled by a cooling plate that is used for cooling a substrate.

### PRIORITY STATEMENT

This U.S. non-provisional patent application claims priority under 35 U.S.C. § 119 to Korean Patent Application 2005-90371 filed on Sep. 28, 2005, the entire contents of which are herein incorporated by reference.

### BACKGROUND OF THE INVENTION

1. Field of the Invention

The present invention relates to an apparatus and method for treating substrates, and more particularly, to a bake unit used for photolithography and method for cooling a heating plate used in the bake unit.

2. Description of the Related Art

Generally, semiconductor devices are manufactured through various processes such as cleaning, depositing, photolithography, etching, and ion implantation. The photolithography process is performed to form a pattern, and this process is important for the integration of the semiconductor device.

A system for performing the photolithography includes a coating unit, an exposing unit, a developing unit, and a bake unit. The photolithography is performed on a wafer while the wafer is sequentially transferred through the bake unit, the coating unit, the bake unit, the exposing unit, the bake unit, the developing unit, and the bake unit. The bake unit includes a heating member to heat the wafer and a cooling member to cool the wafer. Generally, wafers to be processed are divided into groups. Wafers included in the same group are processed under the same process conditions, and wafers in the different groups are processed under different process conditions.

The heating member includes a heating plate to receive a wafer. After a group of wafers is processed, the temperature of the heating plate must be adjusted depending on the processing conditions (e.g., a heating temperature) of the next group of wafers before the next group of wafers is processed. The heating plate can be rapidly heated by increasing the amount of heat applied to the heating plate. However, it takes much time to cool the heating plate since the heating plate is cooled in a natural condition. According to the natural cooling method, it takes about one minute to cool the heating plate one degree Celsius. If the heating temperature decreases from one wafer group to the next wafer group by fifty degrees Celsius, it takes about fifty minutes to cool the heating plate for the next wafer group. Therefore, equipment operating ratio decreases significantly.

### SUMMARY OF THE INVENTION

The present invention provides an apparatus and method capable of cooling a heating plate rapidly.

The present invention also provides an apparatus and method capable of improving equipment operating ratio during photolithography.

Embodiments of the present invention provide bake units heating substrates. The bake unit includes a heating plate heating the substrate, a temperature adjustment plate to be placed on the heating plate to cool the heating plate, a transfer mechanism moving the temperature adjustment plate onto the heating plate. Since the heating plate is force cooled by the temperature adjustment plate, the heating plate can be cooled rapidly.

In some embodiments, the bake unit further includes a cooling plate cooling the substrate. The transfer mechanism moves the temperature adjustment plate between the cooling plate and the heating plate. Since the temperature adjustment plate is moved to the heating plate after the temperature adjustment plate is cooled by the cooling plate, the heating plate can be cooled more rapidly by the large temperature difference between the heating plate and the cooling plate.

In another embodiments, the heating plate and the cooling plate are arranged side by side, and the transfer mechanism includes first and second arms moving the temperature adjustment plate between the cooling plate and the heating plate and an arm actuating member actuating the first and second arms.

In further embodiments, the arm actuating member includes two pulleys spaced apart from each other, a belt wound around the pulleys, a motor rotating one of the pulleys, an upper bracket coupled to an upper portion of the belt for mounting the first arm thereto, and a lower bracket coupled to a lower portion of the belt for mounting the second arm thereto, wherein the first arm and the second arm are moved in opposite directions at the same time.

Another embodiments of the present invention provide substrate treating apparatuses performing photolithography. A processing portion includes a coating unit to perform coating on a substrate, a developing unit to perform developing on the substrate, and a bake unit to heat or cool the substrate before or after the coating or the developing. An index portion includes a cassette mounting to receive a cassette in which substrates are contained and a robot pathway provided with a robot to transfer the substrate between the cassette mounting and the processing portion. An interface portion includes a robot to transfer the substrate between the processing portion and an exposing portion that performs exposing. The bake unit includes a heating plate heating the substrate, a temperature adjustment plate to be placed on the heating plate to cool the heating plate, and a transfer mechanism moving the temperature adjustment plate onto the heating plate.

In some embodiments, the bake unit further includes a cooling plate cooling the substrate, and the transfer mechanism moves the temperature adjustment plate between the cooling plate and the heating plate.

In another embodiments, the processing portion further includes a pathway disposed in a first direction and provided with a robot to transfer the substrate between the coating unit and the bake unit or between the developing unit and the bake unit, wherein the cooling plate and the heating plate are arranged side by side in a second direction perpendicular to the first direction.

In further embodiments, the transfer mechanism includes a first arm moving the substrate or the temperature adjustment plate between the cooling plate and the heating plate, a second arm moving disposed at a height different from the first arm to move the substrate or the temperature adjustment plate between the cooling plate and the heating plate, and an arm actuating member actuating the first arm and the second arm.

In yet further embodiments, the processing portion further includes a first processing chamber to which the coating unit and the bake unit are installed, the first processing chamber being provided with a pathway along which a first robot moves to transfer the substrate between coating unit and the bake unit, and a second processing chamber divided from the first processing chamber in a stacked fashion to receive the developing unit and the bake unit, the second processing chamber being provided with a pathway along which a second robot moves to transfer the substrate between the developing unit and the bake unit. Alternatively, the processing portion may include a single processing chamber or three processing chamber.

In even further embodiments, the temperature adjustment plate has the same shape as the substrate.

Further another embodiments of the present invention provide methods for cooling a heating plate, including cooling the heating plate used in a bake unit for heating a substrate. The cooling of the heating plate is performed with a temperature adjustment plate that is cooler than the heating plate by providing the temperature adjustment plate on the heating plate.

In further embodiments, the temperature adjustment plate is cooled by a cooling plate that is used for cooling the substrate, and then the temperature adjustment plate is moved to the heating plate. The heating plate and the cooling plate are arranged side by side, and another temperature adjustment plate is used to cool the heating plate in turns, wherein while one of the two temperature adjustment plates is placed on the heating plate to cool the heating plate, the other is cooled on the cooling plate.

In still further embodiments, the movement of the temperature adjustment plates between the heating plate and the cooling plate is carried out by two arms that are coupled to a belt at different heights and moved by the belt in opposite directions at the same time.

Still another embodiments of the present invention provide methods for treating a substrate to perform photolithography. The method includes providing a heating plate at a first heating temperature when a first wafer group is processed, and providing the heating plate at a second heating temperature when a second wafer group is processed. If the second heating temperature is lower than the first heating temperature, the providing of the heating plate at the second heating temperature includes cooling the heating plate forcibly, and the forcible cooling of the heating plate includes cooling the heating plate with a temperature adjustment plate that is cooler than the heating plate by providing the temperature adjustment plate on the heating plate.

In further embodiments, the forcible cooling of the heating plate further includes cooling the temperature adjustment plate by moving the temperature adjustment plate onto a cooling plate that is used for cooling the substrate before moving the temperature adjustment plate onto the heating plate.

In still further embodiments, the forcible cooling of the heating plate further includes providing a first temperature adjustment plate on a cooling plate positioned beside the heating plate to cool the substrate, and providing a second temperature adjustment plate on the heating plate; and moving the second temperature adjustment plate to the cooling plate and moving the first temperature adjustment plate to the heating plate.

In other embodiments, the temperature adjustment plate has the same shape as the substrate.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view schematically showing a structure of a substrate treating apparatus according to the present invention;

FIG. 2 is a perspective view showing an example of a processing portion of the substrate treating apparatus depicted in FIG. 1;

FIG. 3 is a plan view showing a first processing chamber of the processing portion depicted in FIG. 2;

FIG. 4 is a plan view showing a second processing chamber of the processing portion depicted in FIG. 2;

FIG. 5 is a perspective view showing an inner structure of a bake unit of the processing portion depicted in FIG. 2;

FIG. 6 is a plan view of the bake unit depicted in FIG. 5;

FIG. 7 is a side-sectional view of a cooling member depicted in FIG. 5; and

FIGS. 8A to 8D are views showing a method for cooling a heating member according to the present invention.

### DETAILED DESCRIPTION OF THE INVENTION

Reference will now be made in detail to the preferred embodiments of the present invention, examples of which are illustrated in the accompanying drawings. However, the present invention is not limited to the embodiments illustrated herein after, and the embodiments herein are rather introduced to provide easy and complete understanding of the scope and spirit of the present invention. Therefore, in the drawings, the shapes of elements can be exaggerated for clarity.

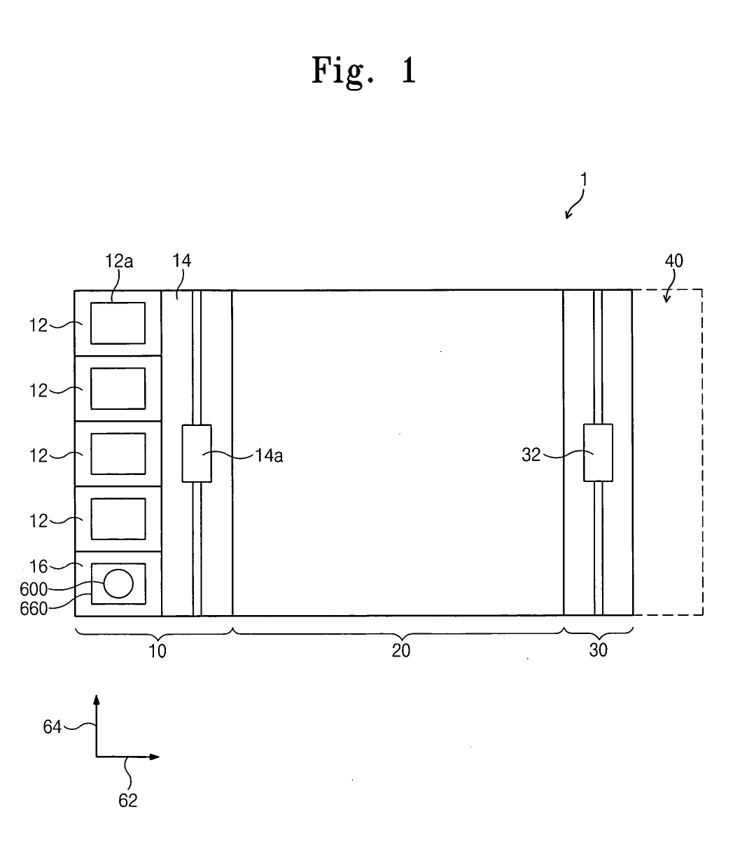

FIG. 1 is a view schematically showing a structure of a substrate treating apparatus 1 according to the present invention. The substrate treating apparatus 1 performs photolithography on a wafer. Referring to FIG. 1, the substrate treating apparatus 1 includes an index portion 10, a processing portion 20, and an interface portion 30 that are sequentially arranged side by side in a predetermined direction (hereinafter, referred to as a first direction 62). The index portion 10 includes cassette mountings 12 and a robot pathway 14. Cassettes 12a accommodating semiconductor substrates such as wafers are placed on the cassette mountings 12. On the robot pathway 14, a robot 14a is installed to transfer the cassette 12a between the cassette mounting 12 and the processing portion 20. The robot 14a is capable of moving in a direction perpendicular to the first direction 62 on a horizontal plane (hereinafter, referred as a second direction 64) and in a vertical direction. Mechanisms for moving the robot 14a in horizontal and vertical directions are well known to those of ordinary skill in the art. Thus, description thereof will be omitted.

The processing portion 20 performs a coating process to coat photosensitive material such as photoresist on a wafer, and after an exposing process is performed on the wafer, the processing portion 20 performs a developing process to remove an exposed region or non-exposed region of the photoresist from the wafer. The processing portion 20 is provided with coating units, developing units, and bake units.

The interface portion 30 is provided on a side of the processing portion 20 and connected to an exposing portion 40. A robot 32 is disposed at the interface portion 30 to transfer wafers between the exposing portion 40 and the processing portion 20. The robot 32 has a mechanism allowing movement in the second direction 64 and in the vertical direction.

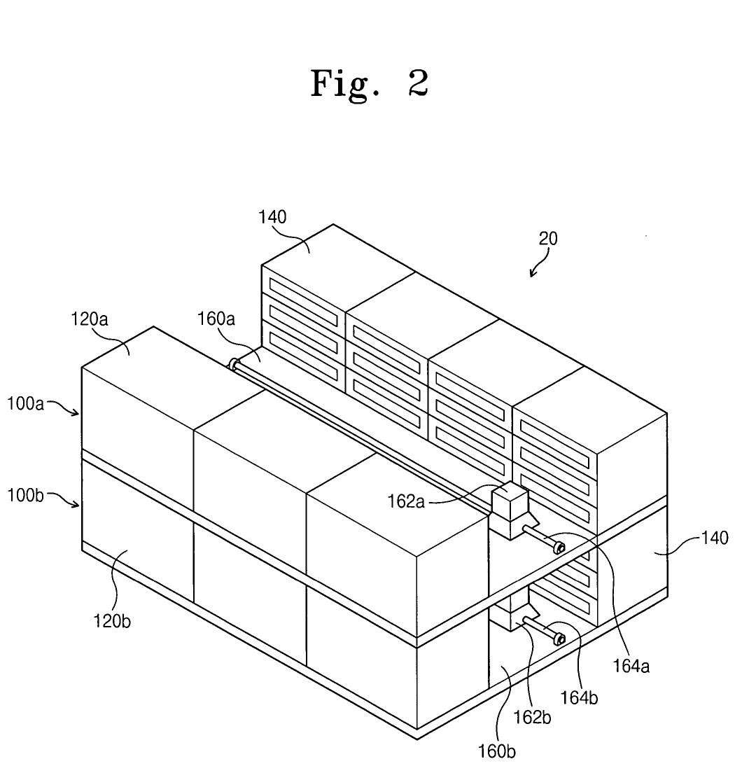

FIG. 2 is a perspective view showing an example of the processing portion 20 depicted in FIG. 1. The processing portion 20 includes a first processing chamber 100a and a second processing chamber 100b that are stacked. The first processing chamber 100a is provided with units performing a coating process, and the second processing chamber 100b is provided with units performing a developing process. That is, the first processing chamber 100a is provided with coating units 120a and bake units 140, and the second processing chamber 100b is provided with developing units 120b and bake units 140. According to this example, the first processing chamber 100a may be disposed above the second processing chamber 100b. Alternatively, the first processing chamber 100a can be disposed under the second processing chamber 100b. In this structure of the substrate treating apparatus 1, wafers are sequentially moved along the index portion 10, the first processing chamber 100a, the interface portion 30, the exposing portion 40, the interface portion 30, the second processing chamber 100b, and the index portion 10. That is, during photolithography process, the wafers are moved in up and down directions through the loop made by the substrate treating apparatus 1.

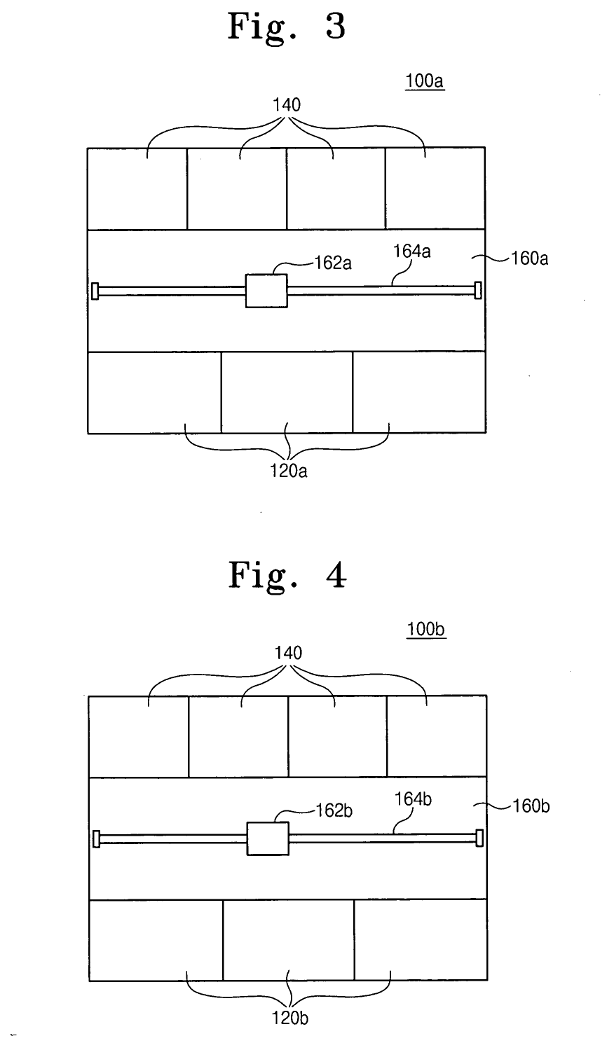

FIG. 3 is a plan view of the first processing chamber 100a. Referring to FIG. 3, the first processing chamber 100a is provided at a center with a first pathway 160a extended in the first direction 62. The first pathway 160a has one end connected to the index portion 10 and the other end connected to the interface portion 30. The bake units 140 are arranged in a row along the first pathway 160a at one side of the first pathway 160a, and the coating units 120a are arranged in a row along the first pathway 160a at the other side of the first pathway 160a. In this arrangement, the bake units 140 and the coating units 120a are stacked in a vertical direction. A first robot 162a is installed on the first pathway 160a to transfer the wafers among the interface portion 30, the coating units 120a, the bake units 140, and the index portion 10. For the linear movement of the first robot 162a in the first direction 62, a guide rail 164a is provided on the first pathway 160a.

FIG. 4 is a plan view of the second processing chamber 100b. Referring to FIG. 4, the second processing chamber 100b is provided at a center with a second pathway 160b extended in the first direction 62. The second pathway 160b has one end connected to the index portion 10 and the other end connected to the interface portion 30. The bake units 140 are arranged in a row along the second pathway 160b at one side of the second pathway 160b, and the developing units 120b are arranged in a row along the second pathway 160b at the other side of the second pathway 160b. In this arrangement, the bake units 140 and the developing units 120b are stacked in a vertical direction. A second robot 162b is installed on the second pathway 160b to transfer the wafers among the interface portion 30, the developing units 120b, the bake units 140, and the index portion 10. For the linear movement of the second robot 162b in the first direction 62, a guide rail 164b is provided on the second pathway 160b.

Alternatively, the first processing chamber can be provided with the first pathway on one side and the coating units and the bake units on the other side. Further, the second processing chamber can be provided with the second pathway on one side and the developing units and the bake units on the other side.

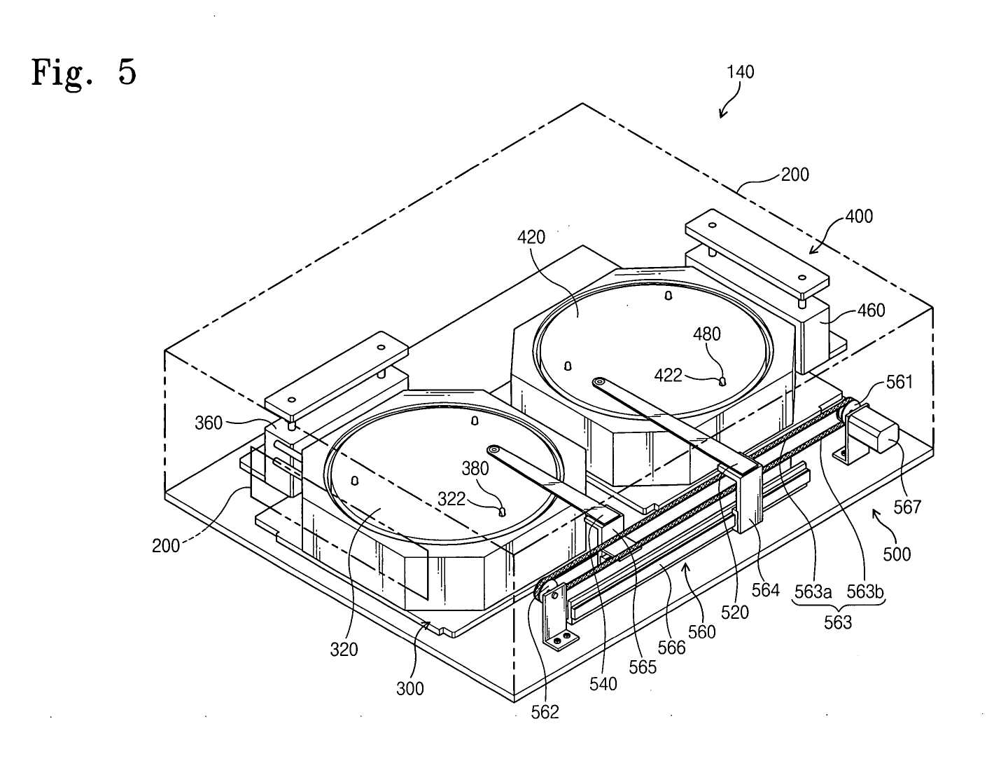

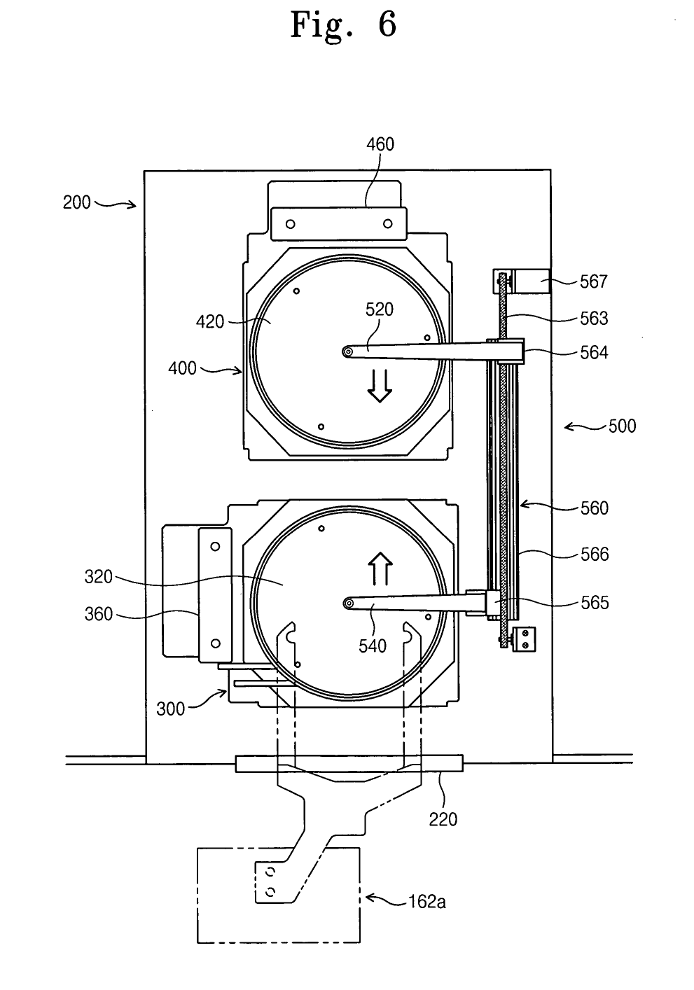

FIG. 5 is a perspective view showing an inner structure of the bake unit 140 of the present invention, and FIG. 6 is a plan view of the bake unit 140 depicted in FIG. 5. The bake units 140 may have the same structure. Hereinafter, the bake unit 140 installed in the first processing chamber 100a will be described as an example. Referring to FIGS. 5 and 6, the bake unit 140 includes a case 200, a cooling member 300, a heating member 400, and a transfer mechanism 500. The case 200 is shaped like a cuboid. The case 200 defines an entrance 220 on a side facing the first pathway 160a to allow a wafer to pass therethrough. The wafer is pushed into and pulled out of the entrance 220 by the first robot 162a.

In the case 200, the cooling member 300 and the heating member 400 are installed side by side. The cooling member 300 and the heating member 400 are arranged in a direction perpendicular to the first pathway 160a, that is, in the second direction 64. The cooling member 300 is placed adjacent to the entrance 220, and the heating member 400 is placed away from the entrance 220. Owing to this arrangement of the cooling member 300 and the heating member 400, the outside of the case 200 is minimally affected by the heat generated from the heating member 400.

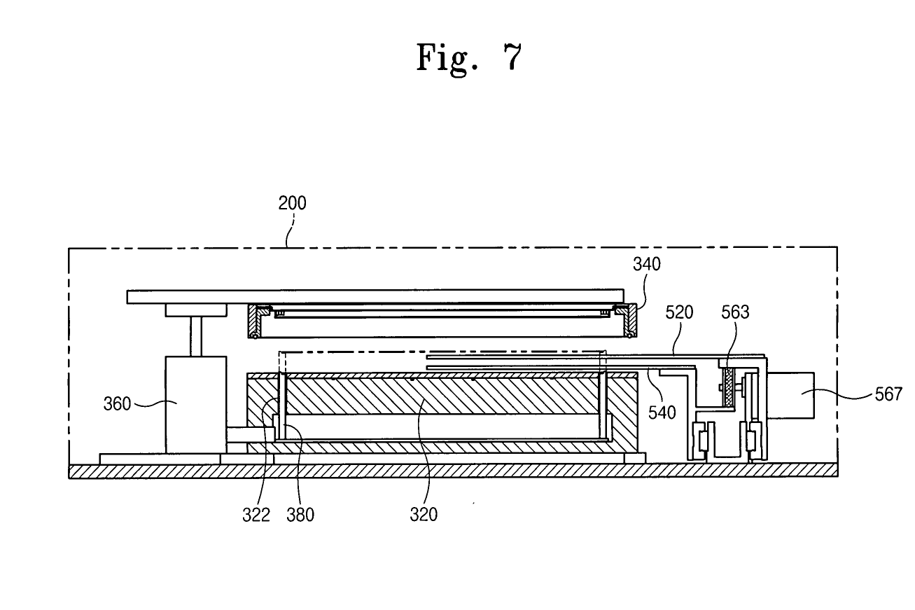

FIG. 7 is a side-sectional view of the cooling member 300. Referring to FIG. 7, the cooling member 300 includes a cooling plate 320 and a cover 340. The cooling plate 320 is shaped like a disc. In the cooling plate 320, a wafer cooling unit is provided. For example, a cooling water line (not shown) can be provided in the cooling plate 320. The cover 340 forms a closed space together with a top of the cooling plate 320. The closed space is provided to prevent the thermal atmosphere around the wafer from being disturbed by the surroundings when the wafer is cooled. Therefore, the cooling efficiency can be maintained without decrease. A vertical actuator 360 is installed on a side of the cooling plate 320 to move the cover 340 up and down. The cooling plate 320 defines through holes 322 in which lift pins 380 move up and down. The through holes 322 are located such that the movements of a first arm 520 and a second arm 540 of the transfer mechanism 500 (described later) are not disturbed. A lifting unit (not shown) moves the lift pins 380 in up and down directions to settle the wafer on the cooling plate 320 or lift up the wafer off the cooling plate 320.

Referring again to FIG. 6, the heating member 400 includes a heating plate 420 and a cover (not shown). The heating plate 420 is shaped like a disc. In the heating plate 420, a wafer heating unit is provided. For example, a heating coil (not shown) can be installed in the heating plate 420, and optionally, predetermined heating patterns (not shown) can be formed on the heating plate 420. The cover forms a closed space together with a top of the heating plate 420. The closed space is provided to prevent the thermal atmosphere around the wafer from spreading to the surroundings when the wafer is heated. Therefore, the heating efficiency can be maintained without decrease. A vertical actuator 460 is installed on a side of the heating plate 420 to move the cover up and down. The heating plate 420 defines through holes 422 in which lift pins 480 move up and down. The through holes 422 are located such that the movements of the first arm 520 and the second arm 540 of the transfer mechanism 500 (described later) are not disturbed. A lifting unit (not shown) moves the lift pins 480 in up and down directions to settle the wafer on the heating plate 420 or lift up the wafer off the heating plate 420.

The transfer mechanism 500 transfers the wafer between the heating plate 420 and the cooling plate 320 installed in the case 200. The transfer mechanism 500 includes the first arm 520, the second arm 540, and an arm actuating member 560. The first and second arms 520 and 540 are shaped like a rod. Each of the first and second arms 520 and 540 is used to lift up the wafer from the lift pins 380 or the lift pins 480, and settle the wafer on the lift pins 380 or the lift pins 480. The arm actuating member 560 linearly moves the first and second arms 520 and 540 between the cooling plate 320 and the heating plate 420.

The arm actuating member 560 includes a first pulley 562, a second pulley 561, a belt 563, an upper bracket 564, a lower bracket 565, a guide rail 566, and a motor 567. At one side of the cooling plate 320, the first pulley 562 is provided, and at one side of the heating plate 420, the second pulley 561 is provided. One of the pulleys 562 and 561 is coupled to the motor 567. The belt 563 is wound around the first and second pulleys 562 and 561. The pulleys 562 and 561 and the belt 563 are disposed such that the half of the belt 563 is placed upward and the other half is placed downward. The upper bracket 564 is fixed to an upper belt portion 563a of the belt 563, and the lower bracket 565 is fixed to a lower belt portion 563b.

The motor 567 is repeatedly rotated back and forth such that the upper bracket 564 is linearly moved between the first pulley 562 and the second pulley 561 in a horizontal direction while the lower bracket 565 is linearly moved between the second pulley 561 and the first pulley 562 in a horizontal direction. The upper bracket 564 and the lower bracket 565 are fixed to the belt 563 in such a manner that when the upper bracket 564 is moved adjacent to the first pulley 562, the lower bracket 565 is moved adjacent to the second pulley 561. The guide rail 566 is provided in the case 200 to guide the upper and lower brackets 564 and 565 linearly.

The first arm 520 is coupled to the upper bracket 564, and the second arm 540 is coupled to the lower bracket 565. With the above-described structure, the first arm 520 and the second arm 540 move in opposite directions without interference. For example, while the first arm 520 transfers one wafer from the cooling plate 320 to the heating plate 420, the second arm 540 can transfer another wafer from the heating plate 420 to the cooling plate 320.

In the example above, the transfer mechanism 500 is designed to transfer the wafers along a linear path. However, the transfer mechanism 500 can be designed to transfer the wafers while rotating the wafers in opposite directions.

Generally, wafers are divided into groups, and wafers included in the same group are processed under the same process conditions if the wafers in the same group undergo the same process. The process using the apparatus of the present invention includes baking, coating, and developing. The baking includes heating and cooling. The heating includes pre-heating (e.g., adhesion) before the coating, post-heating (e.g., soft baking) after the coating, pre-heating (e.g., baking after the exposing) before the developing, and post-heating (e.g., hard baking) after the developing. Each baking is performed by different bake units 140.

In an embodiment, a wafer heating temperature (hereinafter, referred to as a heating temperature) during the baking is described as a processing condition, and only one of the bake units 140 is described. After the photolithography process (including the heating) is performed on a group of wafers (hereinafter, referred to as a first wafer group), another group of wafers (hereinafter referred to as a second wafer group) is introduced to the processing portion 20 for the lithography process. If the heating temperature for the second wafer group (hereinafter, referred to as a second heating temperature) is different from the heating temperature for the first wafer group (hereinafter, referred to as a second heating temperature), the temperature of the heating plate 420 is adjusted before the second wafer group is processed. If the second heating temperature is higher than the first heating temperature, the more amount of heat is applied to the heating plate 420. On the contrary, if the second heating temperature is lower than the first heating temperature, the heating plate 420 is cooled. Hereinafter, a structure and method for rapidly cooling the heating plate 420 will be described.

If the heating plate 420 is cooled in a natural condition, the equipment operating ratio decreases because it takes much time to cool the heating plate 420. Therefore, according to the present invention, the heating plate 420 is force cooled. For the forced cooling of the heating plate 420, a temperature adjustment plate 600 is used. The temperature adjustment plate 600 is cooler than the heating plate 420. The temperature adjustment plate 600 is placed on the heating plate 420 to cool the heating plate 420 by changing heat with the heating plate 420. The heat exchange between the temperature adjustment plate 600 and the heating plate 420 may be carried out by conduction.

Preferably, the temperature adjustment plate 600 is cooled before it is placed on the heating plate 420 to further reduce the time required for cooling the heating plate 420. In this case, the temperature adjustment plate 600 can be cooled by the cooling plate 320 that is provided for cooling wafers. Further, a plurality of temperature adjustment plates 600 can be used for cooling the heating plate 420. In this case, preferably, two temperature adjustment plates 600 are used in turns. While one of the temperature adjustment plates 600 is used to cool the heating plate 420, the other can be cooled by the cooling plate 320. Then, the one of the temperature adjustment plates 600 used for cooling the heating plate 420 is moved to the cooling plate 320, and the other cooled by the cooling plate 320 is moved to the heating plate 420.

Preferably, the temperature adjustment plate 600 has the same shape as the wafer since other components are constructed suitable for the shape of the wafer. For example, the transfer units such as the first robot 162a, the second robot 162b, the first arm 520, and the second arm 540 are constructed to transfer objects having a shape like the wafer. Also, the heating plate 420 and the cooling plate 320 are shaped suitable for heating and cooling objects having a shape like the wafer. The temperature adjustment plate 600 may be formed of the same material as the wafer. Alternatively, the temperature adjustment plate 600 can be formed of metal to facilitate the heat exchange between the temperature adjustment plate 600 and the heating plate 420.

A plurality of temperature adjustment plates 600 are provided in the substrate treating apparatus 1. The substrate treating apparatus 1 is provided with containers to accommodating the temperature adjustment plates 600, and the index portion 10 or the first and second processing chambers 100a and 100b may be provided with container mountings to receive the containers.

A method for treating wafers using the substrate treating apparatus will now be described according to the present invention. Only one of the bake units 140 provided in the first processing chamber 100a is exemplarily described for clarity. Initially, the heating plate 420 is maintained at a first heating temperature to heat a first wafer group. After the first wafer group is completely heated, the temperature of the heating plate 420 is adjusted to a second heating temperature. If the second heating temperature is higher than the first heating temperature, more heat is applied to the heating plate 420 by, for example, a heat coil installed in the heating plate 420. If the second heating temperature is lower than the first heating temperature, the heating plate 420 is force cooled. Then, the second wafer group is processed.

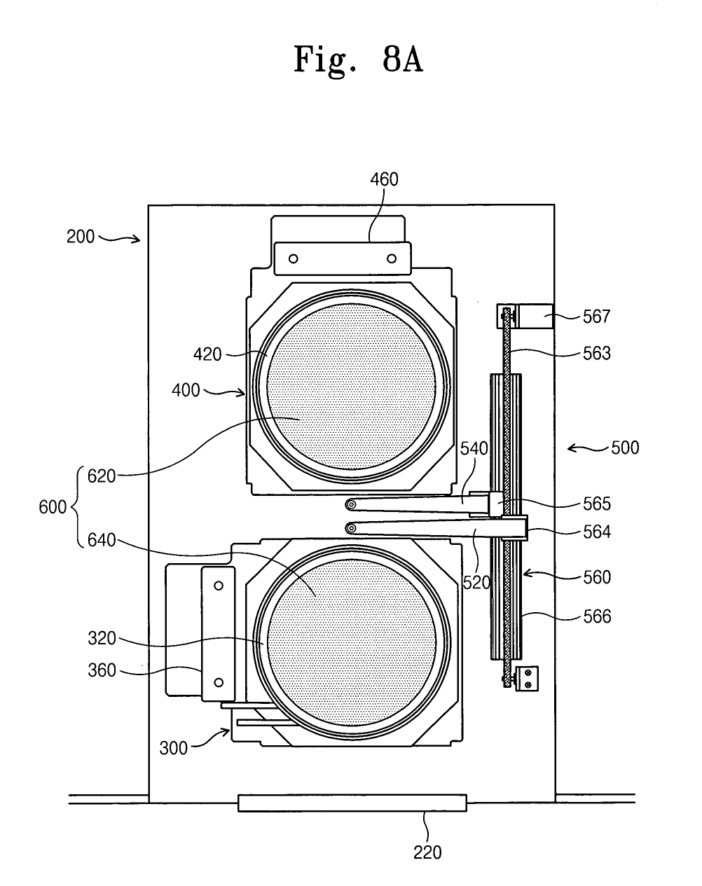

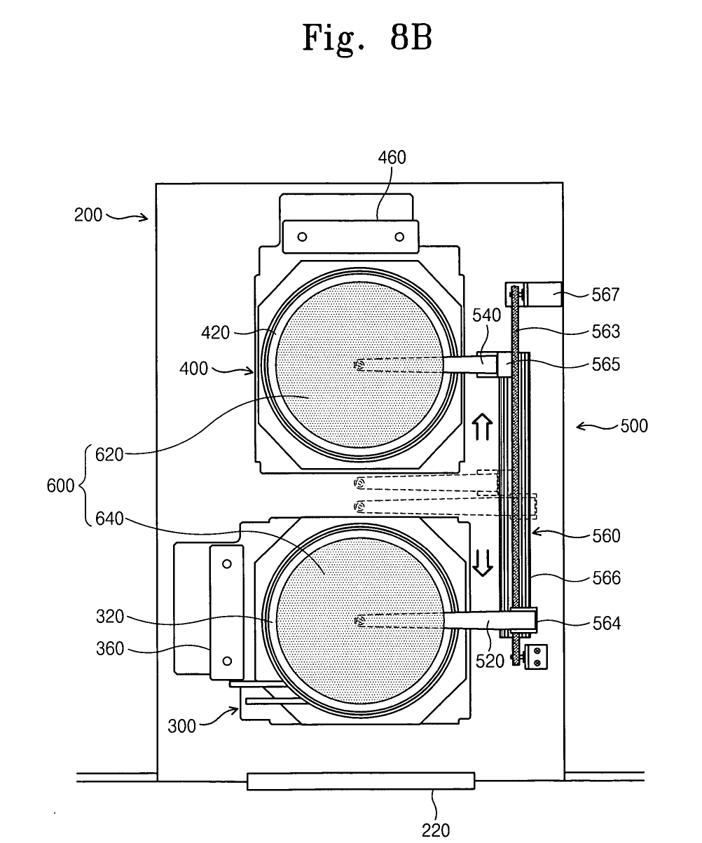

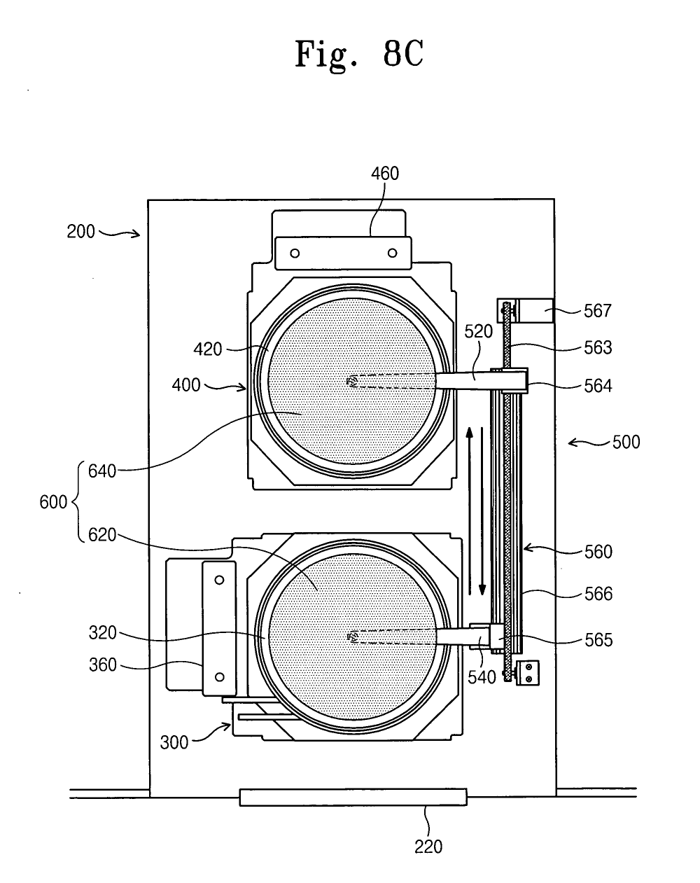

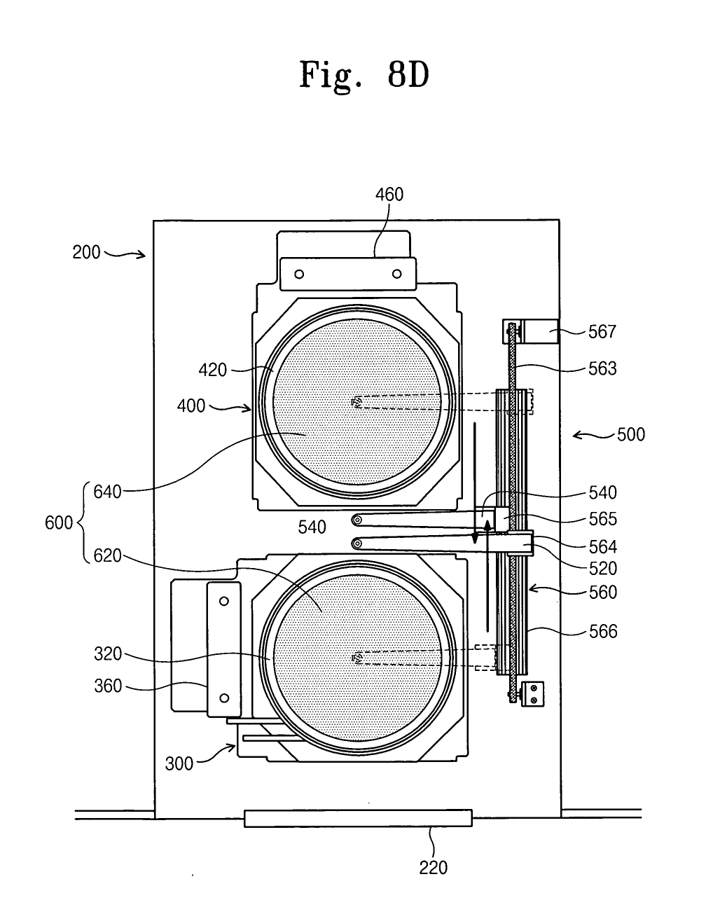

The heating plate 420 is force cooled as follows. First, the first robot 162a takes a first temperature adjustment plate 620 from a container 660 (refer to FIG. 1) and moves the first temperature adjustment plate 620 to an upper side of the cooling plate 320 of the bake unit 140. The first temperature adjustment plate 620 is placed on the cooling plate 320 and cooled by the cooling plate 320. When the first temperature adjustment plate 620 is cooled to a predetermined temperature, the second arm 540 moves the first temperature adjustment plate 620 from the cooling plate 320 to the heating plate 420. Again, the first robot 162a takes a second temperature adjustment plate 640 from the container 660 and moves the second temperature adjustment plate 640 to an upper side of the cooling plate 320. The second temperature adjustment plate 640 is placed on the cooling plate 320. The first arm 520 and the second arm 540 are positioned between the heating plate 420 and the cooling plate 320. The heating plate 420 is cooled by the first temperature adjustment plate 620, and the second temperature adjustment plate 640 is cooled by the cooling plate 320 (refer to FIG. 8A).

After a predetermined time, the first and second temperature adjustment plates 620 and 640 are lifted up from the heating plate 420 and the cooling plate 320 by the lift pins 480 and 380, respectively. The first arm 520 receives the second temperature adjustment plate 640 placed above the cooling plate 320 from the lift pins 380, and the second arm 540 receives the first temperature adjustment plate 620 placed above the heating plate 420 from the lift pins 480 (Refer to FIG. 8B).

The second arm 540 moves the first temperature adjustment plate 620 from the heating plate 420 to the cooling plate 320, and at the same time, the first arm 520 moves the second temperature adjustment plate 640 from the cooling plate 320 to the heating plate 420 (Refer to FIG. 8C).

Then, the first and second arms 520 and 540 are placed between the cooling plate 320 and the heating plate 420. The heating plate 420 is cooled by the second temperature adjustment plate 640, and the first temperature adjustment plate 620 is cooled by the cooling plate 320 (refer to FIG. 8D). After a predetermined time, the first arm 520 moves the first temperature adjustment plate 620 back to the heating plate 420 from the cooling plate 320, and the second arm 540 moves the second temperature adjustment plate 640 back to the cooling plate 320 from the heating plate 420. This operation is repeated until the heating plate 420 is cooled to the second heating temperature. After the heating plate 420 is completely cooled, the temperature adjustment plate 600 placed on the cooling plate 320 is moved to the container 660 by the first robot 162a. The temperature adjustment plate 600 placed on the heating plate 420 is moved to the cooling plate 320 by the transfer mechanism 500, and then returned to the container 660 by the first robot 162a.

In this embodiment, the processing portion 20 is provided with the first processing chamber 100a and the second processing chamber 100b that are stacked. However, the heating plate cooling method of the present invention can be applied to other various apparatuses having a cooling plate and a heating plate.

According to the present invention, the heating plate is force cooled, so that the time required for cooling the heating plate can be reduced, and therefore the equipment operating ratio can be improved.

Further, according to the present invention, since the temperature adjustment plate is placed on the heating plate, the heat exchange between the temperature adjustment plate and the heating plate can be carried out by conduction. Therefore, the time required for cooling the heating plate can be reduced much more.

Furthermore, according to the present invention, the temperature adjustment plate is cooled by the cooling plate before the temperature adjustment plate is used to cool the heating plate, so that the time required for cooling the heating plate can be reduced still more.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A bake unit comprising:
a heating plate heating a substrate;
a temperature adjustment plate to be placed on the heating plate to cool the heating plate; and
a transfer mechanism moving the temperature adjustment plate onto the heating plate.

2. The bake unit of claim 1, further comprising a cooling plate cooling the substrate, wherein the transfer mechanism moves the temperature adjustment plate between the cooling plate and the heating plate.

3. The bake unit of claim 2, wherein the heating plate and the cooling plate are arranged side by side, and the transfer mechanism includes:
first and second arms moving the temperature adjustment plate between the cooling plate and the heating plate; and
an arm actuating member actuating the first and second arms.

4. The bake unit of claim 3, wherein the arm actuating member includes:
two pulleys spaced apart from each other;
a belt wound around the pulleys;
a motor rotating one of the pulleys;
an upper bracket coupled to an upper portion of the belt for mounting the first arm thereto; and
a lower bracket coupled to a lower portion of the belt for mounting the second arm thereto,
wherein the first arm and the second arm are moved in opposite directions at the same time.

5. A substrate treating apparatus comprising:
a processing portion including a coating unit to perform coating on a substrate, a developing unit to perform developing on the substrate, and a bake unit to heat or cool the substrate before or after the coating or the developing;
an index portion including a cassette mounting to receive a cassette in which substrates are contained and a robot pathway provided with a robot to transfer the substrate between the cassette mounting and the processing portion; and
an interface portion including a robot to transfer the substrate between the processing portion and an exposing portion that performs exposing,
wherein the bake unit includes:
a heating plate heating the substrate;
a temperature adjustment plate to be placed on the heating plate to cool the heating plate; and
a transfer mechanism moving the temperature adjustment plate onto the heating plate.

6. The substrate treating apparatus of claim 5, wherein the bake unit further includes a cooling plate cooling the substrate, and the transfer mechanism moves the temperature adjustment plate between the cooling plate and the heating plate.

7. The substrate treating apparatus of claim 6, wherein the processing portion further includes a pathway disposed in a first direction and provided with a robot to transfer the substrate between the coating unit and the bake unit or between the developing unit and the bake unit,
wherein the cooling plate and the heating plate are arranged side by side in a second direction perpendicular to the first direction.

8. The substrate treating apparatus of claim 7, wherein the transfer mechanism includes:
a first arm moving the substrate or the temperature adjustment plate between the cooling plate and the heating plate;
a second arm moving disposed at a height different from the first arm to move the substrate or the temperature adjustment plate between the cooling plate and the heating plate; and
an arm actuating member actuating the first arm and the second arm.

9. The substrate treating apparatus of claim 5, wherein the processing portion further includes:
a first processing chamber to which the coating unit and the bake unit are installed, the first processing chamber being provided with a pathway along which a first robot moves to transfer the substrate between coating unit and the bake unit; and
a second processing chamber divided from the first processing chamber in a stacked fashion to receive the developing unit and the bake unit, the second processing chamber being provided with a pathway along which a second robot moves to transfer the substrate between the developing unit and the bake unit.

10. The substrate treating apparatus of claim 5, wherein the temperature adjustment plate has the same shape as the substrate.

11. A method for cooling a heating plate, comprising cooling the heating plate used in a bake unit for heating a substrate,
wherein the cooling of the heating plate is performed with a temperature adjustment plate that is cooler than the heating plate by providing the temperature adjustment plate on the heating plate.

12. The method of claim 11, wherein the temperature adjustment plate is cooled by a cooling plate that is used for cooling the substrate, and then the temperature adjustment plate is moved to the heating plate.

13. The method of claim 12, wherein the heating plate and the cooling plate are arranged side by side, and another temperature adjustment plate is used to cool the heating plate in turns,
wherein while one of the two temperature adjustment plates is placed on the heating plate to cool the heating plate, the other is cooled on the cooling plate.

14. The method of claim 13, wherein the movement of the temperature adjustment plates between the heating plate and the cooling plate is carried out by two arms that are coupled to a belt at different heights and moved by the belt in opposite directions at the same time.

15. A method for treating a substrate to perform photolithography, the method comprising:
providing a heating plate at a first heating temperature when a first wafer group is processed; and
providing the heating plate at a second heating temperature when a second wafer group is processed,
wherein, if the second heating temperature is lower than the first heating temperature, the providing of the heating plate at the second heating temperature includes cooling the heating plate forcibly,
wherein the forcible cooling of the heating plate includes cooling the heating plate with a temperature adjustment plate that is cooler than the heating plate by providing the temperature adjustment plate on the heating plate.

16. The method of claim 15, wherein the forcible cooling of the heating plate further includes cooling the temperature adjustment plate by moving the temperature adjustment plate onto a cooling plate that is used for cooling the substrate before moving the temperature adjustment plate onto the heating plate.

17. The method of claim 15, wherein the forcible cooling of the heating plate further includes:
providing a first temperature adjustment plate on a cooling plate positioned beside the heating plate to cool the substrate, and providing a second temperature adjustment plate on the heating plate; and
moving the second temperature adjustment plate to the cooling plate and moving the first temperature adjustment plate to the heating plate.

18. The method of claim 15, wherein the temperature adjustment plate has the same shape as the substrate.
